(19) United States
(12) Patent Application Publication
(10) Pub. No.: US 2014/0092518 A1
(43) Pub. Date: Apr. 3, 2014

(54) Method For Suppressing Electrical Discharges Between A Web Exiting An Unwinding Roll And A First Conveyance Roller

(71) Applicant: Kelly Robinson, Fairport, NY (US)

(72) Inventor: Kelly Robinson, Fairport, NY (US)

(73) Assignee: ELECTROSTATIC ANSWERS LLC, Fairport, NY (US)

(21) Appl. No.: 13/633,856

(22) Filed: Oct. 2, 2012

(51) Int. Cl. H05F 1/00

(52) U.S. Cl. CPC H05F 1/00
USPC 361/212

(57) ABSTRACT

When neutralizing the static charges on both sides of a web exiting an unwinding roll, the inside surface of the web may carry a high level of static charge from the unwinding roll to the first conveyance roller. An electrical discharge between the charged inside surface of the web and the first conveyance roller may damage a sensitive, high value coating or layer on the inside surface of the web. Disclosed is a method for suppressing an electrical discharge between the charged inside surface of a web exiting an unwinding roll and a first conveyance roller. The method comprises neutralizing static charges on the outside surface of the unwinding roll using a static dissipater, separating the web from the roll at an unwinding nip, neutralizing a first portion of the static charges on the inside surface of the web to suppress electrical discharges between the web and the first conveyance roller using a static dissipater located near web just before the web touches the first conveyance roller, and neutralizing the remaining second portion of the static charges on the inside surface of the web after the web has exited the first conveyance roller.

### RELATED APPLICATION

This patent application claims priority to provisional U.S. Patent Application 61/542,325 filed on Oct. 3, 2011 and entitled, “Method For Suppressing Electrical Discharges Between The Web Exiting An Unwinding Roll And The First Conveyance Roller”

### FIELD

The claimed invention generally relates to a method for neutralizing static charges, and more particularly to a method for using commercially available bipolar ion emitting devices to neutralize static charges on a web exiting an unwinding roll.

### BACKGROUND

Electrostatic charges on webs cause problems for roll-to-roll manufacturing operations. Control of static on thin, flexible webs is important for the production of packaging materials. Static charges can attract dust and contaminants to the web, shock operators, ignite flammable solvents in printing or coating operations, and cause sticking in sheeting operations. Since electrically active components are susceptible to damage from electrostatic discharges, more effective charge control in roll-to-roll manufacturing is required to build or assemble electronic products including printed electronic circuits, electronic displays and inexpensive solar cells.

Static problems in the printing industry drove the development of early static dissipating devices. In U.S. Pat. No. 836,576 to HARDWICKE, a static dissipater is disclosed that is formed using a grooved plate having needles seated and clamped in the grooves. The electrostatic charge on nearby objects induces ions to form near the tips of the needles. Static dissipaters that operate by induction are termed passive devices because no external source of power is needed for their operation. However, passive devices become inactive when the electrostatic charge on the nearby object is too small to induce ionization. As a consequence, passive devices have a characteristic of dissipating static to a low, non-zero threshold level.

Six passive static dissipaters have been disclosed; (1) a needle or an array of needles as described above, (2) a static brush, (3) tinsel, (4) a rod wrapped with tinsel, (5) an ionizing cord, and (6) an ionizing rod. In U.S. Pat. No. 1,093,491 to SMITH, a (2) static brush is claim that is formed by a slit tube holding wire fabric having conductive strands. The strands need not touch the charged object. Rather, the static brush with conductive fibers must be placed simply within the field of static electricity. In U.S. Pat. No. 1,120,984 to THOMPSON, a (3) tinsel static discharger is disclosed that is made by clamping tinsel to a light, strong rod. In U.S. Pat. No. 1,396,318 to BUNGER, a (4) rod wrapped with tinsel static discharger is disclosed that is made by a core of copper or brass pipe upon which is wound a coil of metallic tinsel. In U.S. Pat. No. 5,690,014 to LARKIN, a (5) static cord is claimed made of non-conductive fiber strands braided to form a cord. One of the strands contains conductive microfibers that provide many ionizing points. In U.S. Pat. No. 5,690,014 to LARKIN, a (6) ionizing rod is claimed made of conductive fiber strands woven into a fabric sleeve sized to fit over a non-conductive core.

An active static dissipater requires an external source of power. In U.S. Pat. No. 940,431 to CHAPMAN, a static dissipater is disclosed having one or more discharge points that are connected to an AC high voltage source. The high voltage causes ions to form at the discharge points. Active devices have the characteristic of being able to dissipate static to a very low level that is much smaller than the threshold level of static characteristic of passive devices. The non-zero, low level is caused by the difference in electronic mobility between negative ions (higher mobility) and positive ions (lower mobility). Since the negative ions move at a higher speed through air, AC static bars typically provide an abundance of negative ions.

Seven active ionizers have been disclosed; (1) the AC static bar as describe above, (2) an air assisted ionizer, (3) a grid controlled ionizer, (4) a capacitively coupled AC ionizer, (5) an AC biased brush or a pair of DC biased static brushes, (6) a radioactive dissipater, and (7) a pulsed DC ionizer. In U.S. Pat. No. 1,169,428 to ROGERS, a (2) air assisted static dissipater is claimed that is a metal tube having a row of needles and holes to allow hot air inside to tube to blow onto the charge surface. In U.S. Pat. No. 940,429 to CHAPMAN, a (3) grid controlled ionizer is claimed that is conductor with fine points energized with a DC voltage opposite in polarity to that of the surface to be neutralized and interposing a screen between the ionizer and the surface to be neutralized. In U.S. Pat. No. 2,239,695 to BENNETT, a (4) capacitively coupled AC ionizer is claimed having discharge pins that, rather than being connected directly to the high voltage power supply are instead capacitively coupled. Capacitive coupling provides two important advantages. First, the generation of positive and negative ions is balanced thus eliminating the abundance of negative ions resulting in complete neutralization of objects. A second important advantage is the elimination of accidental high voltage shocks to operators and inadvertent sparks from the static bar to nearby grounded objects. In U.S. Pat. No. 4,363,070 to KISTLER, a (5) AC biased brush is claimed for neutralizing charge. And in U.S. Pat. No. 4,517,143 to KISTLER, a (5) pair of DC biased brushes are claimed for uniformly charging a moving web. Disclosed is that the uniform charge may be zero thus neutralizing static on the moving web. In U.S. Pat. No. 2,479,882 to WALLHAUSEN, a (6) radioactive static dissipater is disclosed. And in U.S. Pat. No. 3,711,743 to BOLASNY, a (7) pulsed DC excitation for controlling electrostatic potentials. A significant improvement for pulsed DC static eliminators is claimed in U.S. Pat. No. 4,542,434 to Gehlke where the pulse shape is changed by lengthening the time between ion generating pulses. This allows ions of one polarity to move further thus extending the effective ionization range of the static neutralizer.

In roll-to-roll manufacturing operations, the statically charged object to be neutralized is the web or areas on the web that have been coated or otherwise processed. The passive or active static dissipater in FIG. 1 must be located within the field of static electricity as taught in U.S. Pat. No. 1,093,491 to SMITH. Negative static charges 115 are on the top surface 111 of web 101. A passive or active static dissipater 121 is located within the field of static electricity 133. Ions 119 formed by static dissipater 121 move towards static charges 115 being forced by the electric field 133.

The effectiveness of static dissipaters may be significantly improved by locating them in specific locations. For example, in U.S. Pat. No. 2,449,972 to BEACH shows static dissipaters located where the web exits conveyance rollers facing the side of the web that is not in contact with the rollers. This location is disclosed as preferred as the most convenient position. In subsequent research, (K. L. Clum, “Equilibrium Distribution of Charge on a Moving Conducting Film Web,” IEEE Transactions on Industry Applications, Vol. 25, No. 1, January/February 1989), shows that, in the immediate vicinity of a conveyance roller, the distribution of electrostatic charge on a web varies with the product of web speed and web electrical surface resistivity. For example, the static charge density is highest in the region where the web exits the roller for a web having a surface resistivity in the range 0.6-6×10⁺¹¹ Ohms per square moving at a speed of 1 meter per second.

The static dissipaters as previously describe are typically located to neutralize the charged web to mitigate specific problems. For example, the winding roll at the end of a roll-to-roll manufacturing process can store a large amount of static charge and consequently pose a significant risk of electrical shock to operators. U.S. Pat. No. 3,392,311 to BOETEMANN claims draping electrically grounded conductive strands (tinsel) on the winding roll so that it is substantially free of static.

However, passive and active static dissipaters are not always effective in neutralizing static charge. For example, the active or passive static dissipater in FIG. 2 is ineffective in dissipating a specific pattern of charge on an insulating web. As disclosed in U.S. Pat. No. 7,388,736 to MORIOKA, the lines of force for a sheet having positive charge on one surface and negative charge on the opposite surface, especially if the pattern has a fine pitch, are closed between the negative charges and positive charges. In FIG. 2, web 201 has negative static charges 215 on the top surface 213 and positive static charges 216 on the bottom surface 214. Electric field 233 extends between the positive static charges 216 and the negative static charges 215 The electric field 233 is substantially confined to the region between the top surface 213 and bottom surface 214. Consequently, ions 217 formed by static dissipater 221 are not drawn toward the web 201. Hence, the static eliminators as previously discussed are ineffective in neutralizing a pattern of static charge where one surface has positive charge and the other surface has negative charge.

In U.S. Pat. No. 3,470,417 to GIBBONS, this charge pattern having equal but opposite charges on opposite sides of the material is termed “polar charge.” Claimed is a method of neutralizing polar charge by positioning the web carrying polar charge between two facing, grid controlled AC ionizers. The ionizers are energized in a cooperative way so that when the first ionizer is energized with the positive voltage portion of the AC sinusoidal waveform, the second ionizer is energized with the negative voltage portion of the AC sinusoidal waveform. Hence, ions generated by the first ionizer are attracted towards the web by the ions of opposite polarity generated by the second ionizer. While this method is effective, disclosed in U.S. Pat. No. 7,388,736 to MORIOKA are sequential pairs of ionizers to improve neutralization performance by extending the time that the web is exposed to ions generated by the ionizers.

Polar charge is an important problem because the electric potential of a winding roll in FIG. 3 increases with each wound lap as disclosed in U.S. Pat. No. 7,388,736 to MORIOKA. An electrically neutral web 312 enters a nip formed by polymer covered roller 303 and metal roller 304. Triboelectric charging occurs when two chemically different surfaces touch and separate. Upon exiting the nip, the surface of polymer roller 303 having touched web 312 carries negative static charges 317. The bottom surface of web 314 having touched polymer roller 303 carries positive static charges 316 that are equal in magnitude and opposite in polarity to charge 317 on the surface of the polymer covered roller 303. Note that triboelectric charging between metal roller 304 and the top surface 313 of web 312 is greatly smaller and insignificant compared with the triboelectric charging between polymer roller 303 and the bottom surface 314 of web 312. A passive or active static dissipater 321 is located in a convenient location above the web facing the top surface 313 of the web 312. The static dissipater is positioned within the electric field of positive static charges 316. Consequently, static dissipater delivers negative charges 319 to the top surface of the web. The web entering the winding roll 306 is electrically neutral having positive static charges 316 on the bottom surface 314 and an equal amount of negative static charges 319 on the top surface 313 deposited by the static dissipater. However, the web carries polar charge. An electrostatic voltmeter 331 measures the electric potential of the first lap of the winding roll to be non-zero. The electric potential of one lap is typically in the range ±0.5-±100 volts. For the purpose of illustration, the electric potential of the lap is taken to be −10 volts, which is typical of Tribocharge web surfaces. The voltage is additive with each layer, so that the electric potential of the winding roll with 10 laps would be −100 volts. As the roll builds with thousands of laps, the electric potential of the winding roll can exceed ±20 KV causing sparks, electrical discharges, and shocks to operators.

It is desirable to have a way to neutralize polar charge, defined to be a charge pattern having positive static charges on one surface of a web and an equal amount of negative polarity static charges on the other surface. The means for neutralizing polar charge by supporting the web between pairs of facing AC static dissipaters is expensive. In addition, as the web speed increases beyond one hundred meters per minute, the neutralizing effectiveness decreases of pairs of facing AC static dissipaters. It is desirable to have a method to neutralize polar charge for high speed roll-to-roll manufacturing operations where the web speeds exceed one hundred meters per minute.

Unwinding web from a roll is a unique opportunity to neutralizing static charges as described in U.S. patent application Ser. No. 13/621,291 to ROBINSON, Apparatus And Method For Neutralizing Static Charge On Both Sides Of A Web Exiting An Unwinding Roll. Described is a method for neutralizing static on an unwinding roll using two ionizers as shown in FIG. 4. Static bar SB1 is located to neutralize static on the surface of the unwinding roll. As a result, the inside surface of the web exiting the unwinding roll may have a high level of static charge

A second static bar is used to neutralize static charge on the inside surface of the web. This ionizer could be located along the web span from the unwinding roll to the first roller. However, the location of the web varies as the diameter of the unwinding roll decreases and the performance of static bars varies with the distance between the ionizer and the web. By locating static bar SB2 in FIG. 1 downstream of the first conveyance roller, the spacing between static bar SB2 and the web is fixed. In addition, this location is often much more accessible for ionizer maintenance and cleaning.

The locations of conveyance rollers between the unwinding roll and the static bar that neutralizes the inside surface of the web are critical. As shown in FIG. 4, the web exiting the unwinding roll may have high levels of static charge. The high static on the web in FIG. 4(a) generates electrical discharges in the gap between the web and the roller surface just before the web touches the roller. Within this discharge, air ions of both polarities are generated. Negative ions are attracted to the web, which will partially neutralize the charged, inside web surface. Positive ions will move towards the grounded roller. The result is that the web exiting contact with the first roller is partially neutralized. The static bar located past the rollers that touch only the inside web surface neutralizes the charge remaining on the inside web surface.

### SUMMARY

When neutralizing static on an unwinding roll using the method in FIG. 4, the inside surface of the web exiting the unwinding roll may have a high level of static charge. With this high level of static charge, the inside surface of the web may be exposed to electrical discharges that occur as the web approaches the first conveyance roller. These electrical discharges may have sufficiently energy to damage the surfaces of high value layers or coating on the inside surface of the web.

The electrical discharges between the inside surface of the web and the first conveyance roller may be suppressed by a static dissipater SD3 in FIG. 5 located just before the first conveyance roll. Static dissipater SD3 may be a passive neutralizer such as a static brush, tinsel, ionizing string, or an ionizing rod. While these passive static neutralizers will not completely neutralize static on the web, the performance of these passive neutralizers is sufficient to suppress electrical discharges. Static bar SB2 located after the first conveyance roller has sufficient performance to completely neutralize the static on the web.

The location of the web exiting the unwinding roll to the first conveyance roller in FIG. 5 varies as the diameter of the unwinding roll decreases. Static dissipater SD3 must be located so that it is near the web and so that it does not touch the web. With static dissipater SD3 mounted in a fixed location, the gap between static dissipater SD3 and the web will vary as the location of the web varies. The performance of static dissipation SD3 decreases as the distance to the web increases. To minimize the decrease in performance of static dissipater SD3, it should be located near the first conveyance roller. The distance L from static dissipater SD3 and the surface of the first conveyance roller should be in the range 1-12 inches.

### BRIEF DESCRIPTION OF THE DRAWINGS

It will be appreciated that for purposes of clarity and where deemed appropriate that the various elements in the drawings have not necessarily been drawn to scale in order to better show the features.

FIGS. 1 and 2 illustrate the neutralization of static charges on both sides of a web exiting an unwinding roll that can be unwound in either the clockwise or the counter clockwise direction.

FIG. 3 shows how the static charges on the inside surface of the web exiting the unwinding roll cause electrical discharges between the inside surface of the web and the first conveyance roller.

FIG. 4 shows a first embodiment of the method for suppressing electric discharges between a first conveyance roller and the inside surface of the web exiting the unwinding roll that is turning in the clockwise direction.

FIG. 5 shows a second embodiment of the method for suppressing electric discharges between a first conveyance roller and the inside surface of the web exiting the unwinding roll that is turning in the counter clockwise direction.

FIGS. 6, 7, 8, and 9 illustrate a third embodiment of the method to suppress electrical discharges between a first conveyance roller and the inside surface of a web exiting an unwinding roll where the method is adapted for rolls that may be unwound in either the clockwise or the counter-clockwise direction on an unwind turret having two spindles

### DESCRIPTION

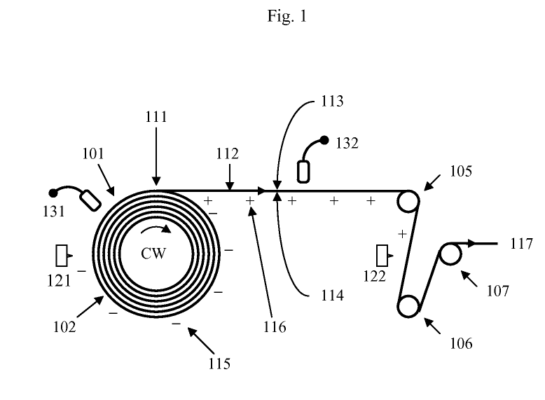

FIG. 1 illustrates the method to neutralize static charges on both sides of a web exiting an unwinding roll turning in the clockwise direction. The web 112 exits the roll 101 at the unwinding nip 111. Tribocharging causes the outside surface 102 of the roll to have negative static charge 115 and causes the inside surface 114 of the web exiting the roll to have positive static charge 116. Static dissipater 121 is positioned to neutralize static charge on the outside surface of the roll. Electrostatic voltmeter 131 confirms that the electric potential of the outside surface of the unwinding roll is zero. As a result of neutralization by static dissipater 121, the outside surface 113 of the web exiting the roll is now electrically neutral. Electrostatic fieldmeter 132 confirms that the electric field near the web exiting the unwinding roll is highly positive due to the positive charge on the inside surface of the web span. Static dissipater 122 is positioned after the first conveyance roller 105 and prior to the second conveyance roller 106 to neutralize static charge on the inside surface of the web. As a result, the exiting web 117 is electrically neutral.

The neutralizing performance of a passive or active static dissipater decreases with increasing distance from the charged object. Static dissipater 121 is positioned to neutralize the outside surface of the roll. However, the outside diameter of the roll decreases with time. For mechanical simplicity, static dissipater 121 is preferably mounted in a fixed position. As the roll diameter decreases, the distance between dissipater 121 and the outside surface 102 of the unwinding roll increases. While static dissipater 121 can be a passive or active, using an active dissipater is preferred because active static dissipaters have a greater range of neutralization than passive static dissipaters. Most preferred is to use a pulsed DC energized ionizer where the pulse shape is changed by lengthening the time between ion generating pulses. This allows ions of one polarity to move further thus extending the effective ionization range of the static neutralizer as describe in U.S. Pat. No. 4,542,434 to Gehlke.

Static dissipater 122 could be located along the first web span 112 exiting the roll 101. However, the outside diameter of the roll 101 decreases with time. For mechanical simplicity, static dissipater 122 is preferably mounted in a fixed position. As the diameter of the unwinding roll 101 decreases, the unwinding nip 111 moves towards the core and the physical location of the first web span 112 moves. Hence, the distance between static dissipater 122 and the first web span 112 would decrease with time changing the neutralizing performance of the dissipater. Locating static dissipater 122 after the first conveyance roll is preferred because the position of the web span is determined by the fixed locations of conveyance rollers 105 and 106. Consequently, the distance between the dissipater 122 and the web is constant. This constant spacing enables good performance of static dissipater 122 when using either passive or active devices. Preferably, static dissipater 122 is a pulsed DC device with balance ion output as taught by No. 3,711,743 to BOLASNY.

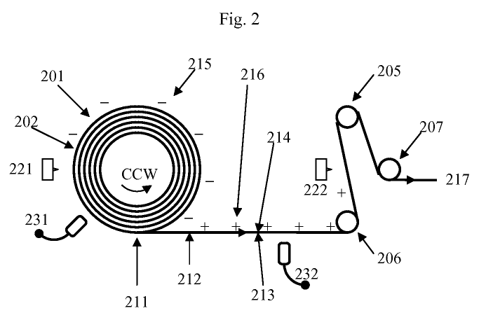

FIG. 2 illustrates the method to neutralize static charges on both sides of a web exiting an unwinding roll turning in the counter clockwise direction. The web 212 exits the roll 201 at the unwinding nip 211. Tribocharging causes the outside surface 202 of the roll to have negative static charge 215 and causes the inside surface 214 of the web exiting the roll to have positive static charge 216. Static dissipater 221 is positioned to neutralize static charge on the outside surface of the roll. Electrostatic voltmeter 231 confirms that the electric potential of the outside surface of the unwinding roll is zero. As a result of neutralization by static dissipater 221, the outside surface 213 of the web exiting the roll is now electrically neutral. Electrostatic fieldmeter 232 confirms that the electric field near the web exiting the unwinding roll is highly positive due to the positive charge on the inside surface of the web span. Static dissipater 222 is positioned after the first conveyance roller 206 and prior to the second conveyance roller 205 to neutralize static charge on the inside surface of the web. As a result, the exiting web 217 is electrically neutral.

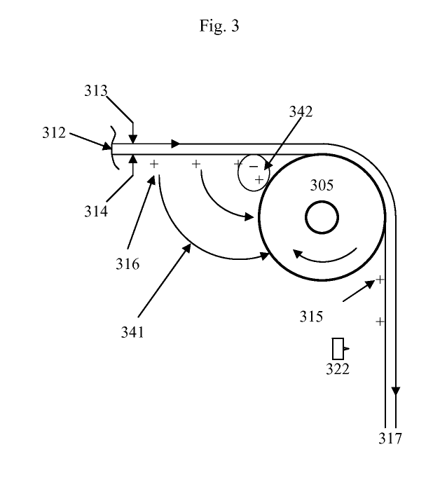

After neutralizing the static charges on the outside surface of the roll, the web 312 in FIG. 3 exiting the roll will have static charges 316 located on the inside surface 314. On the web path between the unwinding roll and static dissipater 322, all conveyance rollers must touch the inside surface of the web. As the charged web 312 approaches the first conveyance roller 305, an electric field the electric field 341 will extend between the static charges 316 and the roller 305. Because roller 305 touches the inside surface 314 of the web, the electric fields 341 do not cross through web 312. When the density of static charges 316 exceeds a threshold level of approximately ±4 μC/m², the electric field exceeds the breakdown strength of air forming an electrical discharge 342, commonly called pre-nip ionization. The electric discharge may dissipate sufficient energy to damage a thin coating or sensitive layer on the inside surface of the web.

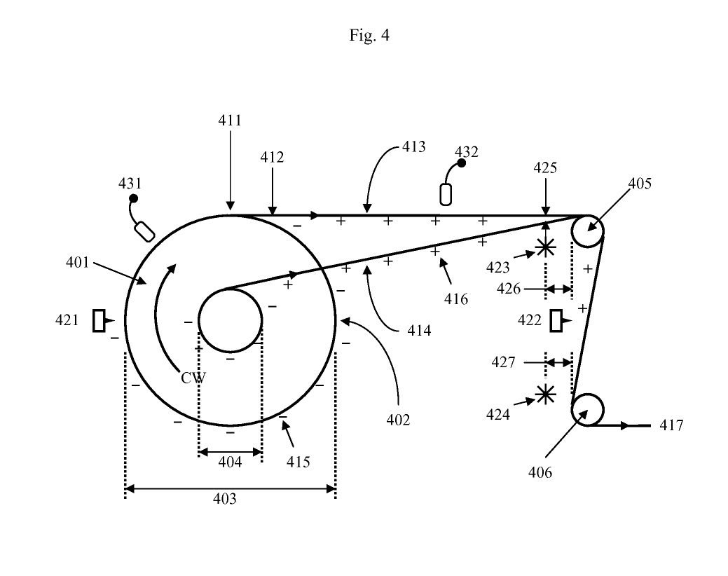

FIG. 4 illustrates a first embodiment of the method to suppress electrical discharges between a first conveyance roller and the inside surface of a web exiting an unwind roll turning in the clockwise direction. A web 412 exits the roll 401 at an unwinding nip 411. Tribocharging causes the outside surface 402 of the unwinding roll to have negative static charge 415 and causes the inside surface 414 of the web exiting the roll to have positive static charge 416. Static dissipater 421 is positioned to neutralize static charge on the outside surface of the roll. Electrostatic voltmeter 431 confirms that the electric potential of the outside surface of the unwinding roll is zero. As a result of neutralization by static dissipater 421, the outside surface 413 of the web exiting the roll is now electrically neutral. Electrostatic fieldmeter 432 confirms that the electric field near the web exiting the roll is highly positive due to the positive charge on the inside surface of the web. Static dissipater 422 is positioned after the first conveyance roller 405 to neutralize static charge on the inside surface of the web. The web is subsequently conveyed over a second conveyance roller 406 and a third conveyance roller 407. As a result, the exiting web 417 is electrically neutral.

Static dissipater 423 is located to neutralize a portion of the static charges 416 on the inside surface 414 of the web. Static dissipater 423 need not dissipate all of the static charges. Rather, static dissipater 423 need only dissipate a portion of the static charges to suppress electrical discharges between the web 412 exiting the unwinding roll and the first conveyance roller 405. Static dissipater 425 can be a passive dissipater such as a static brush, a strand of tinsel, an ionizing cord, or an ionizing rod. Or, static dissipater 425 can be and active dissipater such as a radioactive ionizer, an AC static bar, a pulsed DC static bar, or a pulsed DC static bar where the pulse shape is changed by lengthening the time between ion generating pulses. Preferably, static dissipater 423 is an ionizing cord because an ionizing cord is a low cost static dissipater that has sufficient ionizing performance to suppress electrical discharges between the web and the first conveyance roller.

Static dissipater 423 should be positioned as close to first conveyance roller 405 as possible to minimize the variation in gap 425 between the web and static dissipater 423. However, the neutralizing efficiency of static dissipater 423 decreases significantly when it is positioned too close to first conveyance roller 405. The distance between static dissipater 423 and the surface of first conveyance roller 405 should be in the range 1-12 inches.

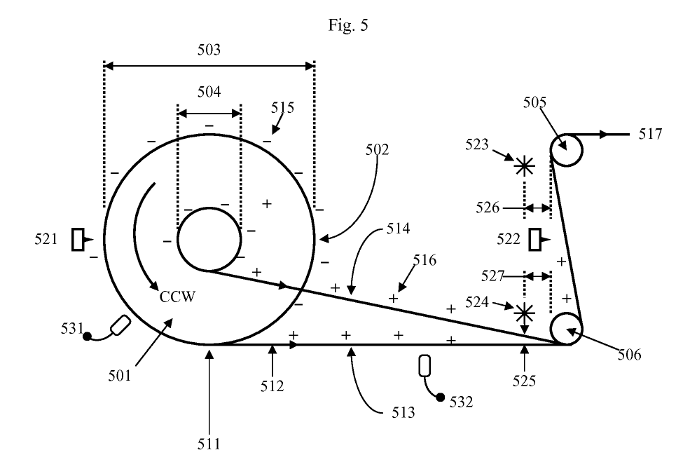

FIG. 5 illustrates the first embodiment of the method to suppress electrical discharges between a first conveyance roller and the inside surface of a web exiting an unwind roll turning in the counter clockwise direction. A web 512 exits the roll 501 at an unwinding nip 511. Tribocharging causes the outside surface 502 of the unwinding roll to have negative static charge 515 and causes the inside surface 514 of the web exiting the roll to have positive static charge 516. Static dissipater 521 is positioned to neutralize static charge on the outside surface of the roll. Electrostatic voltmeter 531 confirms that the electric potential of the outside surface of the unwinding roll is zero. As a result of neutralization by static dissipater 521, the outside surface 513 of the web exiting the roll is now electrically neutral. Electrostatic fieldmeter 532 confirms that the electric field near the web exiting the roll is highly positive due to the positive charge on the inside surface of the web. Static dissipater 522 is positioned after the first conveyance roller 506 to neutralize static charge on the inside surface of the web. The web is subsequently conveyed over a second conveyance roller 505 and a third conveyance roller 507. As a result, the exiting web 517 is electrically neutral.

Static dissipater 524 is located to neutralize a portion of the static charges 516 on the inside surface 514 of the web. Static dissipater 524 need not dissipate all of the static charges. Rather, static dissipater 524 need only dissipate a portion of the static charges to suppress electrical discharges between the web 512 exiting the unwinding roll and the first conveyance roller 505. Static dissipater 524 can be a passive dissipater such as a static brush, a strand of tinsel, an ionizing cord, or an ionizing rod. Or, static dissipater 524 can be and active dissipater such as a radioactive ionizer, an AC static bar, a pulsed DC static bar, or a pulsed DC static bar where the pulse shape is changed by lengthening the time between ion generating pulses. Preferably, static dissipater 524 is an ionizing cord because an ionizing cord is a low cost static dissipater that has sufficient ionizing performance to suppress electrical discharges between the web and the first conveyance roller.

Static dissipater 524 should be positioned as close to first conveyance roller 506 as possible to minimize the variation in gap 525 between the web and static dissipater 524. However, the neutralizing efficiency of static dissipater 524 decreases significantly when it is positioned too close to first conveyance roller 506. The distance between static dissipater 524 and the surface of first conveyance roller 506 should be in the range 1-12 inches.

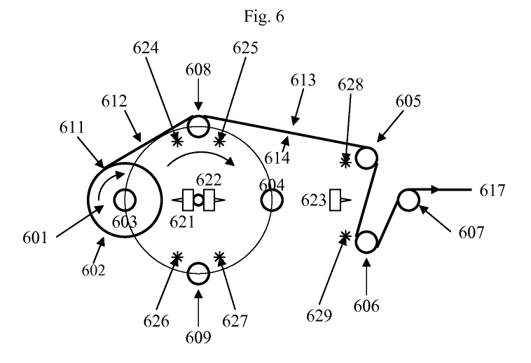

In FIGS. 6, 7, 8 and 9 illustrate a second embodiment of the method to suppress electrical discharges between a first conveyance roller and the inside surface of a web exiting an unwinding roll. Many roll-to-roll manufacturing operations use an unwinding turret in FIG. 6 having a first unwind spindle 603 in a load position farther from conveyance roller 605, 606 and 607 and a second unwind spindle 604 in a run position nearer to the conveyance roller 605, 606 and 607. While an old roll unwinds on spindle 604 in the run position, a new roll may be loaded onto spindle 603 in a load position typically using cranes and other roll handling equipment. The unwind turret is often designed to unwind rolls in either a clockwise or a counter clockwise direction. The advantage of this second embodiment is that the locations of the static dissipaters are fixed and unchanged. Electrical discharges are suppressed while the roll on either spindle 603 or 604 is unwound in either the clockwise or the counter-clockwise direction, and while the turret rotates in either the clockwise or the counter clockwise direction.

FIG. 6 shows a turret unwinder where spindle 604 is in a run position nearer to conveyance roller 605, 606 and 607 and spindle 603 is farther from the conveyance rollers. No web remains on the roll on spindle 604 and a new roll 601 on spindle 603 is rotating in the clockwise direction unwinding web 612. The web 612 exits the roll 601 at the unwinding nip 611. Tribocharging causes the outside surface 602 of the roll to have negative static charge (not shown) and causes the inside surface 614 of the web exiting the roll to have positive static charge (not shown). Static dissipater 621 is positioned to neutralize static charge on the outside surface of the roll on spindle 603. As a result of neutralization by static dissipater 621, the outside surface 613 of the web exiting the roll is now electrically neutral. The web is conveyed over roller 608 that is mounted on the turret and subsequently over roller 605 that is mounted in a fixed location. Static dissipater 623 is positioned after the conveyance roller 605 to neutralize static charge on the inside surface of the web. The web is subsequently conveyed next over conveyance roller 606 and conveyance roller 607. As a result, the exiting web 617 is electrically neutral.

Static dissipater 624 is positioned to neutralize a portion of the static charges on the insides surface 614 of the web before the web touches roller 608. Static dissipater 624 suppresses electrical discharge that would occur between first conveyance roller 608 and the inside surface 614 of the web.

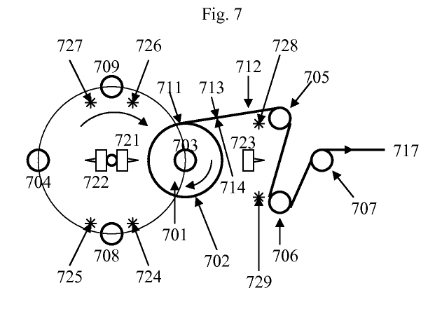

While roll 601 in FIG. 6 is unwinding, the turret rotates in the clockwise direction to move the unwinding roll 601 from the load position that is farther away from conveyance rollers 605, 606 and 607 to the run position that is nearer to the conveyance rollers as shown in FIG. 7. Conveyance roller 608 located above static dissipaters 621 and 622 with unwinding roll 601 in the load position in FIG. 6 rotates with the turret to become conveyance roller 708 in FIG. 7 located below static dissipaters 721 and 722 with unwinding roll 701 in the run position.

FIG. 7 shows a turret unwinder where spindle 704 is in a load position farther from conveyance roller 705, 706 and 707 and spindle 703 is in the run position nearer to the conveyance rollers. The roll 701 on spindle 703 is rotating in the clockwise direction to unwind web 712. The web 712 exits the roll 701 at the unwinding nip 711. Tribocharging causes the outside surface 702 of the unwinding roll to carry static charges (not shown) and causes the inside surface 714 of the web exiting the roll to carry static charges (not shown) having equal magnitude and opposite polarity to the charges on the roll. Static dissipater 721 located on the turret so that it rotates with the turret is positioned to neutralize static charge on the outside surface of the roll on spindle 703. As a result of neutralization by static dissipater 721, the outside surface 713 of the web exiting the roll is now electrically neutral. With the spindle 703 in the run position, the web is conveyed directly from the unwinding nip 711 to roller 705 that is mounted in a fixed location. Static dissipater 723 in a fixed location after the conveyance roller 705 is positioned to neutralize static charge on the inside surface of the web. The web is subsequently conveyed next over conveyance roller 706 and conveyance roller 707. As a result, the exiting web 717 is electrically neutral.

Static dissipater 728 is positioned to neutralize a portion of the static charges on the insides surface 714 of the web before the web touches roller 705. Static dissipater 728 suppresses electrical discharge that would occur between first conveyance roller 705 and the inside surface 714 of the web.

FIG. 6 shows the unwinding roll 601 on spindle 603 in the load position where the outside surface 602 of the roll is neutralized by static dissipater 621. When a roll is on spindle 604, static neutralizer 622 is located to neutralize the outside surface. The geometry is akin to FIG. 7 showing roll 701 in the run position.

Similarly, FIG. 7 shows the roll 701 on spindle 703 in the run position where the outside surface 702 of the roll is neutralized by static dissipater 721. When a roll is on spindle 704, static neutralizer 722 is located to neutralize the outside surface of the roll. The geometry is akin to FIG. 6 showing roll 601.

In FIG. 6 and FIG. 7, the positions of corresponding static dissipaters 621 & 721 located to neutralize the unwinding roll, corresponding static dissipaters 623 & 723 located to neutralize the inside surface of the web, corresponding static dissipaters 624 & 724, 625 & 725, 626 & 726, 627 & 727, 628 & 728, 629 & 729 located to neutralize suppress electrical discharges between a first conveyance roller and the inside surface of the web, and corresponding conveyance rollers 605 & 705, 606 & 706, and 607 & 707 are fixed. The roll loading operations and turret rotation can proceed with no change to the location of the static neutralizers. The advantage of this second embodiment of the method to suppress electrical discharges between a web exiting an unwinding roll and a first conveyance roller is that the locations of the static dissipaters are fixed and unchanged. Electrical discharges are effectively suppressed while a roll on either spindle 603 or 604, with the roll in either the load or run positions, with the roll unwound in either the clockwise or counter clockwise direction, and while the turret rotates in a clockwise direction.

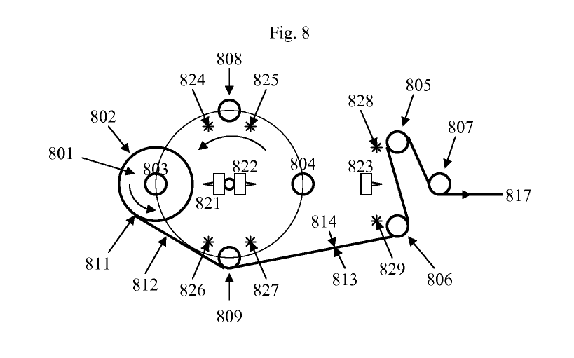

FIG. 8 shows a turret unwinder where spindle 804 is in a run position nearer to conveyance roller 805, 806 and 807 and spindle 803 is farther from the conveyance rollers. No web remains on the roll on spindle 804 and a new roll 801 on spindle 803 is rotating in the counter clockwise direction unwinding web 812. The web 812 exits the roll 801 at the unwinding nip 811. Tribocharging causes the outside surface 802 of the roll to have negative static charge (not shown) and causes the inside surface 814 of the web exiting the roll to have positive static charge (not shown). Static dissipater 821 is positioned to neutralize static charge on the outside surface of the roll on spindle 803. As a result of neutralization by static dissipater 821, the outside surface 813 of the web exiting the roll is now electrically neutral. The web is conveyed over roller 809 that is mounted on the turret and subsequently over roller 806 that is mounted in a fixed location. Static dissipater 823 is positioned after the conveyance roller 806 to neutralize static charge on the inside surface of the web. The web is subsequently conveyed next over conveyance roller 805 and conveyance roller 807. As a result, the exiting web 817 is electrically neutral.

Static dissipater 826 is positioned to neutralize a portion of the static charges on the insides surface 814 of the web before the web touches roller 809. Static dissipater 826 suppresses electrical discharge that would occur between first conveyance roller 809 and the inside surface 814 of the web.

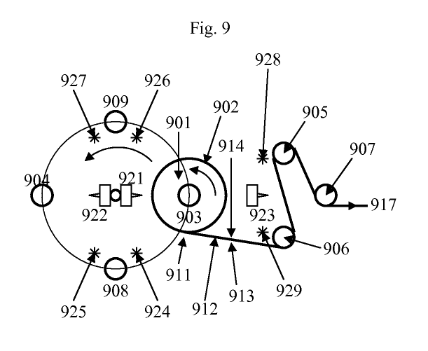

While roll 801 in FIG. 8 is unwinding, the turret rotates in the counter clockwise direction to move the unwinding roll 801 from the load position that is farther away from conveyance rollers 805, 806 and 807 to the run position that is nearer to the conveyance rollers as shown in FIG. 9. Conveyance roller 809 located below static dissipaters 821 and 822 with unwinding roll 801 in the load position in FIG. 8 rotates with the turret to become conveyance roller 909 in FIG. 9 located above static dissipaters 921 and 922 with unwinding roll 901 in the run position.

FIG. 9 shows a turret unwinder where spindle 904 is in a load position farther from conveyance roller 905, 906 and 907 and spindle 903 is in the run position nearer to the conveyance rollers. The roll 901 on spindle 903 is rotating in the counter clockwise direction to unwind web 912. The web 912 exits the roll 901 at the unwinding nip 911. Tribocharging causes the outside surface 902 of the unwinding roll to carry static charges (not shown) and causes the inside surface 914 of the web exiting the roll to carry static charges (not shown) having equal magnitude and opposite polarity to the charges on the roll. Static dissipater 921 located on the turret so that it rotates with the turret is positioned to neutralize static charge on the outside surface of the roll on spindle 903. As a result of neutralization by static dissipater 921, the outside surface 913 of the web exiting the roll is now electrically neutral. With the spindle 903 in the run position, the web is conveyed directly from the unwinding nip 911 to roller 906 that is mounted in a fixed location. Static dissipater 923 in a fixed location after the conveyance roller 906 is positioned to neutralize static charge on the inside surface of the web. The web is subsequently conveyed next over conveyance roller 905 and conveyance roller 907. As a result, the exiting web 917 is electrically neutral.

Static dissipater 929 is positioned to neutralize a portion of the static charges on the insides surface 914 of the web before the web touches roller 906. Static dissipater 929 suppresses electrical discharge that would occur between first conveyance roller 906 and the inside surface 914 of the web.

FIG. 8 shows the unwinding roll 801 on spindle 803 in the load position where the outside surface 802 of the roll is neutralized by static dissipater 821. When a roll is on spindle 804, static neutralizer 822 is located to neutralize the outside surface. The geometry is akin to FIG. 9 showing roll 901 in the run position.

Similarly, FIG. 9 shows the roll 901 on spindle 903 in the run position where the outside surface 902 of the roll is neutralized by static dissipater 921. When a roll is on spindle 904, static neutralizer 922 is located to neutralize the outside surface of the roll. The geometry is akin to FIG. 6 showing roll 601.

In FIG. 8 and FIG. 9, the positions of corresponding static dissipaters 821 & 921 located to neutralize the unwinding roll, corresponding static dissipaters 823 & 923 located to neutralize the inside surface of the web, corresponding static dissipaters 824 & 924, 825 & 925, 826 & 926, 827 & 927, 828 & 928, 829 & 929 located to neutralize suppress electrical discharges between a first conveyance roller and the inside surface of the web, and corresponding conveyance rollers 805 & 905, 806 & 906, and 807 & 907 are fixed. The roll loading operations and turret rotation can proceed with no change to the location of the static neutralizers. The advantage of this second embodiment of the method to suppress electrical discharges between a web exiting an unwinding roll and a first conveyance roller is that the locations of the static dissipaters are fixed and unchanged. Electrical discharges are effectively suppressed while a roll on either spindle 803 or 804, with the roll in either the load or run positions, with the roll unwound in either the clockwise or counter clockwise direction, and while the turret rotates in a clockwise direction.

Accordingly, the claimed invention is limited only by the following claims and equivalents thereto.

What is claimed is:

1. A method for suppressing electrical discharges between a first conveyance roller and a web exiting an roll comprising;
neutralizing static charges on the outside surface of a roll using a static dissipater located in the proximity of the outside surface of the roll;
separating the web from the roll at an unwinding nip;
the web having an outside surface corresponding to the outside surface of the roll;
the web also having an inside surface;
conveying the web over a first conveyance roller positioned to touch in inside surface of the web;
neutralizing a portion of the static charges on the inside surface before the inside surface touches the first conveyance roller; and
neutralizing the static charges remaining on the inside surface of the web using a static dissipater located after the first conveyance roller.

2. The method for neutralizing static in claim 1 wherein the distance between surface of the first conveyance roller and the static dissipater positioned to neutralize a portion of the static charges on the inside surface of the web before it touches the first conveyance roller and the surface of said first roller is no less than 1 inch and no greater than 12 inches.

3. The method for neutralizing static in claim 1 wherein the static dissipater positioned to neutralize a portion of the static charges on the inside surface of the web before it touches the first conveyance roller is selected from the group consisting of a tinsel, an antistatic brush, an ionizing cord, an ionizing rod, a radioactive ion emitter, an AC powered corona ion emitter, a pulsed DC powered corona ion emitter, and a pulsed DC powered corona ion emitter with where the pulse shape is changed by lengthening the time between ion generating pulses.
